(19) United States
(12) Patent Application Publication
(10) Pub. No.: US 2009/0121969 A1
(43) Pub. Date: May 14, 2009

(54) Multi-display system for displaying identical information on multiple display screens situated in different viewing planes for monitoring or demonstrating the activity of the input device's operator

(76) Inventor: Barbara Jean Stremlau Wargo, Streator, IL (US)

Correspondence Address: Michelle N. Schneiderheinze;Hunziker Law Group - Commerce Bank Bldg., 16th Floor, 416 Main Street, Peoria, IL, 61602, US

(21) Appl. No.: 12/243,154

(22) Filed: Oct. 1, 2008

Related U.S. Application Data
(60) Provisional application No. 60/997,598, filed on Oct. 5, 2007.

(51) Int. Cl. G09G 5/00

(52) U.S. Cl. 345/1.3

(57) ABSTRACT

A multi-display screen device including a plurality of display screens with each display screen situated in alternative directions and each display screen displaying identical images. This device can be used with any input device. The preferred embodiment is a two panel display device in which the screen of each panel faces opposite directions. The described system would allow teachers, parents, and employers to inexpensively monitor computer use. The described system can also be used as a teaching and/or demonstration device to allow a person sitting at a different angle from the computer operator to view material on the operator's display screen.

### CROSS-REFERENCE TO RELATED APPLICATIONS

Applicant claims the benefit of Provisional Patent Application No. 60/997,598 filed Oct. 5, 2007.

### STATEMENT REGARDING FEDERALLY SPONSORED RESEARCH OR DEVELOPMENT

There were no federally sponsored research grants or monies used in the development of the described invention.

### NAMES OF THE PARTIES TO A JOINT RESEARCH AGREEMENT

There is no research agreement applicable to the development of the described invention.

### BACKGROUND OF THE INVENTION

Personal computers and other technologies permeate all aspects of our lives. If used appropriately, these devices can increase productivity in the work environment, enrich educational processes and provide boundless amounts of useful information on demand. However, the potential for abusive use of these technologies has led to the development of monitoring and blocking systems to curtail undesirable activity. Most of these monitoring or blocking technologies rely on software programs that record the activity of the computer operator or block pre-defined activity. However, these programs require some level of skill to setup and administer.

Further, monitoring software only gives information about what activity has occurred—it does not prevent the activity. And, blocking software is not always effective. Also, the time spent administering and maintaining the above-described software can be onerous in a work or academic environment. The present system provides a time and cost efficient alternative to allow monitoring of computer, internet and other visual devices.

### BRIEF SUMMARY OF THE INVENTION

This invention resolves problems of prior art in that it provides a simple, inexpensive, and compact device for monitoring the output viewed by the operator of an image creating device such as a personal computer. It achieves this improvement by providing immediate access to generated output by displaying the output images on multiple display screens located in different viewing planes. Thus, a parent, teacher, supervisor, or other monitoring individual can view the output image while located in a position other than directly behind the operator (i.e., child, student, employee).

The invention provides multiple viewing screens joined by a connecting means. The preferred connecting means would allow each screen to be moved independently in an up-down and side-to-side direction. The display screens could also be joined with a rigid connecting means to hold the screens at predetermined angles. The pivotal and rigid connecting means may be encased within the outer device housing, or the device housing itself could be used as the connecting means. A preferred connecting means would be a hinge whereby the display screens would sit in a “tent” formation.

The invention also provides for an image transmission means to move image data between the multiple display screens. Such transmissions means, such as common VGA cables, are well known in the prior art. The transmission means may be encased within the outer device housing, or independent from the housing. Such transmission means may be permanently attached to the display screens or detachable.

The invention may also include multiple switches to turn the multiple display screens of the device on and off. These switches can be located on all display screens or on less than all display screens.

### BRIEF DESCRIPTION OF THE DRAWINGS

FIG. 1 is a two-dimensional drawing showing the front view of a two-display-screen device.

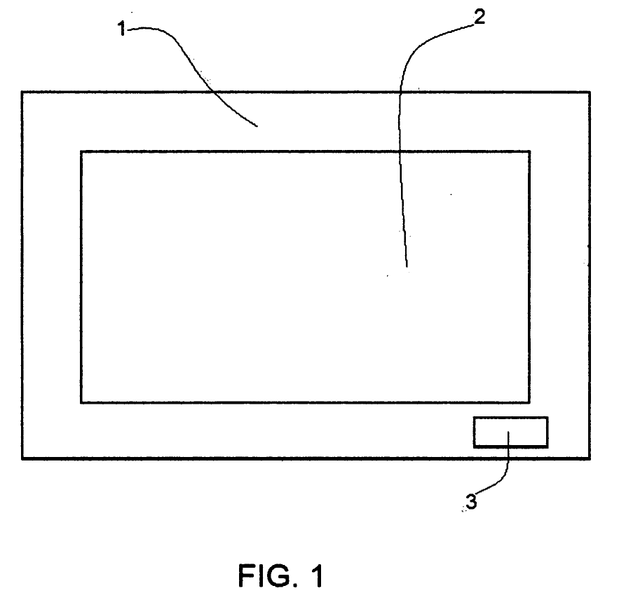

FIG. 2 is a two-dimensional drawing showing the back view of a two-display-screen device.

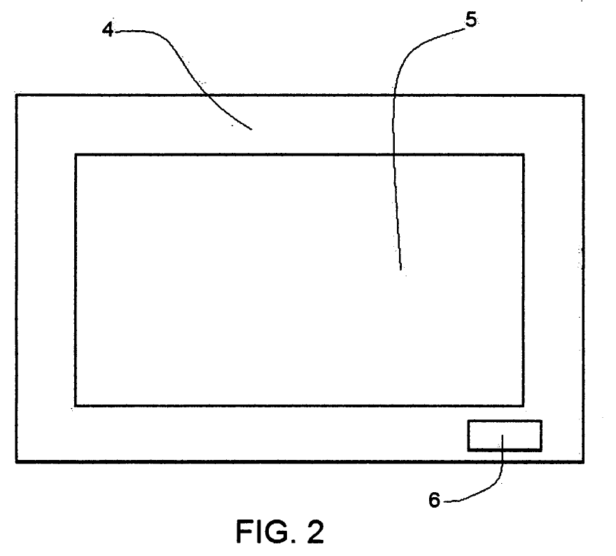

FIG. 3 shows a perspective view of a two-display-screen device with the connecting means.

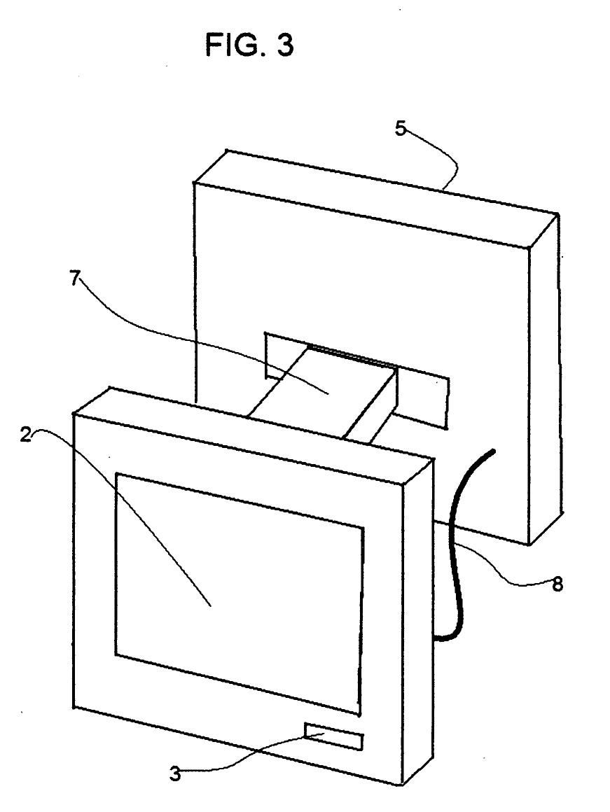

FIG. 4 shows a perspective view of a two-display-screen device in a “tent” configuration.

FIG. 5 shows a perspective view of a laptop computer with a two-display-screen device in a “tent” configuration.

FIG. 6 shows a view of a two-display-screen device.

FIG. 7 shows a view of a two-display-screen device.

FIG. 8 shows a view of a two-display-screen device.

### DETAILED DESCRIPTION OF THE INVENTION

The present invention consists of a multi-display screen device including a plurality of display screens with each screen situated in alternative directions and each screen displaying identical images. This device can be used with any input device. The described system would allow teachers, parents, and employers to inexpensively monitor computer use. The described system can also be used as a teaching and/or demonstration device to allow a person sitting at a different angle for the computer operator to view material on the operator's display screen.

For the purpose of this specification, a display screen includes any generally available computer monitor screen or television display unit including liquid crystal displays or plasma screen displays. For the purpose of this specification a switch includes any generally available mechanism to control the flow of electricity to the display screen. For the purpose of this specification, a transmission means includes any generally available video cable transmission technology or wireless video transmission technology. For the purpose of the specification, an input device includes any device that is capable of generating a video output signal including computers, VCRs, DVD players, or digital media players.

The preferred embodiment is a two display screen device in which each display screen faces opposite directions. The operators display screen 2 is attached to a power switch 3 that allows the display screen to be powered down when not being used. The display screen and power switch are encased in a display housing 1. The additional display screen 5 may also be attached to a power switch 6 that allows that display screen 5 to be powered down when not in use. Alternatively, the power switch 3 attached to the operator's display screen may be used to power down the additional display screen or screens. The additional display screen 5 and power switch (if present) should also be encased in a display housing 4. The housing 4 of the additional display screen may be connected to, or be part of the housing 1 for the operator's display screen.

The operator's display screen housing 1 and the additional display screen housing 4 should be attached to each other through a connecting means such as a hinge 9, multiple hinges, a bracket 7, a bracket and a hinge, or a ball-and-socket connection, or any combination thereof which creates the desired range of motion for either or both display screens.

The operator's display screen 2 and the additional display screen 5 or screens are connected by a transmission means 8 whereby the image from the operator's display screen 2 is transmitted to the additional display screen. This transmission means could consist of a detachable VGA cable or other suitable video signal transmission cable that would be inserted into appropriate ports on each display screen's housing, or if a fixed connection is desired, the transmission means could be a transmission cable permanently connected to the display screens, or to the display screens' housing, or encased within a shared housing.

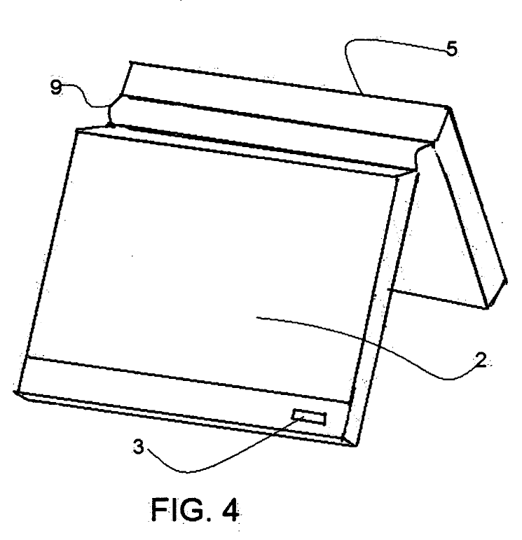

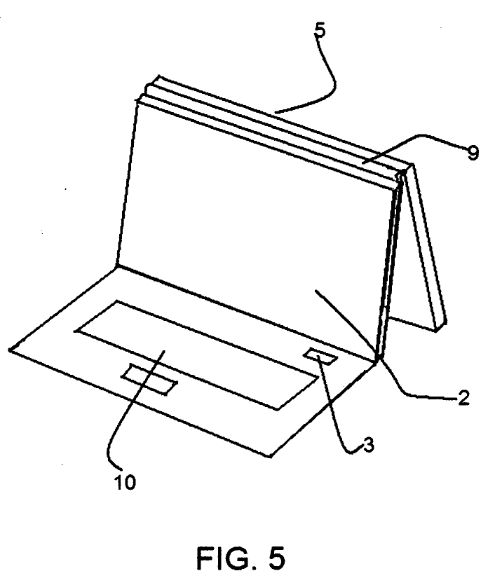

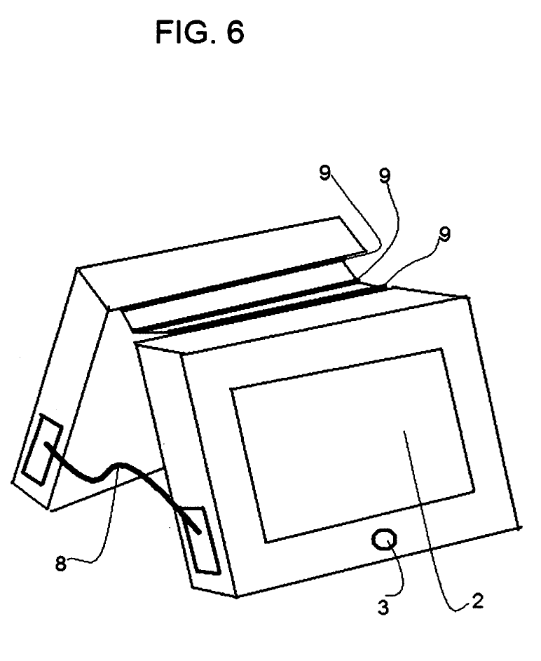

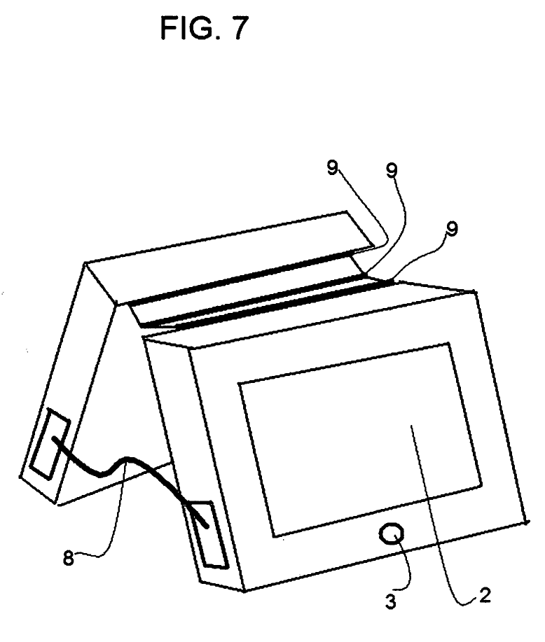

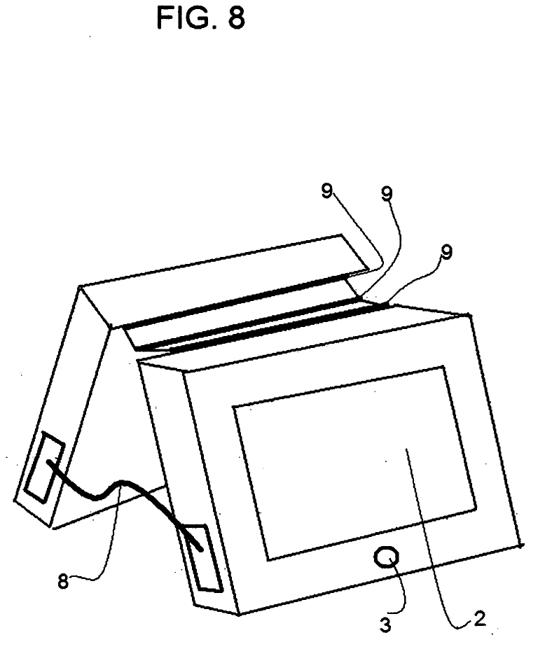

As illustrated in FIG. 4, an alternate embodiment of the invention, is a two-display-screen device in which each display-screen housing is attached by a hinge 9 so as to form a “tent” formation. As illustrated in FIG. 5, another embodiment of the invention would incorporate a two display screens into a laptop computer in a foldable and portable configuration. In this embodiment, the two display-screens are hinged together so that the display screens form a “tent” when opened, but the display screens will lay flat when the laptop is stored. Another embodiment (not illustrated) would have, the laptop display housing contain two display screens each oriented in opposite directions but contained in the same housing, such that the screens would be back-to back. As illustrated in FIG. 6, FIG. 7 and FIG. 8, another embodiment would have two separate display-screen housings oriented in opposite directions and connected by three hinges oriented in an alternating-up-down configuration such that the display housings could be folded together (for storage or transportation) with the display screens facing each other.

What is claimed is:

1. A multi-display screen device, comprising a plurality of connected display screens oriented in alternative directions with each display screen displaying identical images produced by a single input device.

2. The multi-display screen device described in claim 1 wherein the input device is a computer.

3. A multi-display screen device, comprising two connected display screens oriented in alternative directions with each display screen displaying identical images produced by a single input device.

4. The multi-display screen device described in claim 3 wherein the screens are connected to each other by brackets.

5. The multi-display screen device described in claim 3 wherein the screens are connected to each other by hinges.

6. The multi-display screen device described in claim 3 wherein the screens are connected to each other by ball and socket joints.

7. The multi-display screen device described in claim 3 wherein the screens are contained in a single screen housing.

8. The multi-display screen device described in claim 4 wherein the input device is a computer.

9. The multi-display screen device described in claim 5 wherein the input device is a computer.

10. The multi-display screen device described in claim 6 wherein the input device is a computer.

11. The multi-display screen device described in claim 7 wherein the input device is a computer.

12. The multi-display screen device described in claim 5 wherein the device is a laptop computer with the display screens connected at the top of each display screen, and with the display screens being foldable such that the display screens stack on top of each other and then fold on top of the laptop keyboard.

13. The multi-display screen device described in claim 3 wherein the device is a laptop computer with the display screens being contained in the same screen housing, and with the display screens being foldable such that the display screens lay on top of the laptop keyboard.

14. The multi-display screen device described in claim 3 wherein the display-screens are connected by three hinges oriented in an alternating-up-down configuration such that the display screens can be folded together with the front of each display screen facing the front of the other display screen.

15. The multi-display screen device described in claim 14 wherein the input device is a computer.
